(19) United States
(12) Patent Application Publication
(10) Pub. No.: US 2008/0278931 A1
(43) Pub. Date: Nov. 13, 2008

(54) Tool structure with illumination

(75) Inventors: Ching-Huei Wu, Taipei Hsien (TW); Ching-Mo Wu, Taipei Hsien (TW)

Correspondence Address: TROXELL LAW OFFICE PLLC;SUITE 1404, 5205 LEESBURG PIKE, FALLS CHURCH, VA, 22041, US

(73) Assignee: Unity Opto Technology Co., Ltd.

(21) Appl. No.: 11/798,318

(22) Filed: May 11, 2007

(51) Int. Cl. B25B 23/18

(52) U.S. Cl. 362/120; 362/119

(57) ABSTRACT

A tool structure with illumination comprises a tool body; a light source group mounted on the front end of the tool body; and at least one battery. The light source group is composed of at least one electrical socket and at least one light-emitting device. The light-emitting device is mounted on the electrical socket. The battery supplies electric power for the light source group.

### FIELD OF THE INVENTION

The present invention relates to a tool structure with illumination that has a light source group on the front end of the tool body for providing the operation position with illumination to be suitable for use in auxiliary lighting apparatus, hand tool or the like.

### BACKGROUND OF THE INVENTION

It is difficult to operate the hand tool in a location lacking sufficient intensity of illumination. In addition, it is also difficult to operate the hand tool when the user's body or the hand tool causes a shadow region. There are disclosed several prior patents, which have complicated structures, numerous components and high production cost. In addition, in the prior patents, the light beams emitted from the light-emitting device will be blocked by the screwdriver head ahead of the light-emitting device, causing the formation of a shadow region on the operation position in the front.

In view of this, the present inventor makes diligent studies in providing general public with a tool structure with illumination that has simplified structure, reduced cost and is free of a shadow region.

### SUMMARY OF THE INVENTION

It is an object of the present invention to provide a tool structure with illumination, wherein a light source group has a light-emitting device mounted on an electrical socket so as to enable the user himself to replace the damaged light-emitting device and to change the light color by replacing the light-emitting device.

It is another object of the present invention to provide a tool structure with illumination that has a light source group on the front end of the tool body so that the operation position is free of a shadow region and the operation position can be provided with sufficient intensity of illumination without the use of additional lighting device, thereby increasing overall practicability and convenience.

In order to achieve the foregoing object, a tool structure with illumination of the present invention is comprised of a tool body; a light source group mounted on the front end of the tool body; and at least one battery. The light source group is composed of at least one electrical socket and at least one light-emitting device. The light-emitting device is mounted on the electrical socket. The battery supplies electric power for the light source group.

The aforementioned and other objects and advantages of the present invention will be readily clarified in the description of the preferred embodiments and the enclosed drawings of the present invention.

### BRIEF DESCRIPTION OF THE DRAWINGS

FIG. 1 is an elevational view showing a first preferred embodiment of the present invention.

FIG. 2 is an elevational, decomposed view showing the first preferred embodiment of the present invention.

FIG. 3 is a schematic, cross-sectional view showing the assembled structure of the first preferred embodiment of the present invention.

FIG. 4 is a schematic view showing the utilization status of the first preferred embodiment of the present invention.

FIG. 5 is an elevational, decomposed view showing a second preferred embodiment of the present invention.

FIG. 6 is a schematic, cross-sectional view showing the assembled structure of the second preferred embodiment of the present invention.

FIG. 7 is a schematic view showing the utilization status of the second preferred embodiment of the present invention.

### DETAILED DESCRIPTION OF THE PREFERRED EMBODIMENT

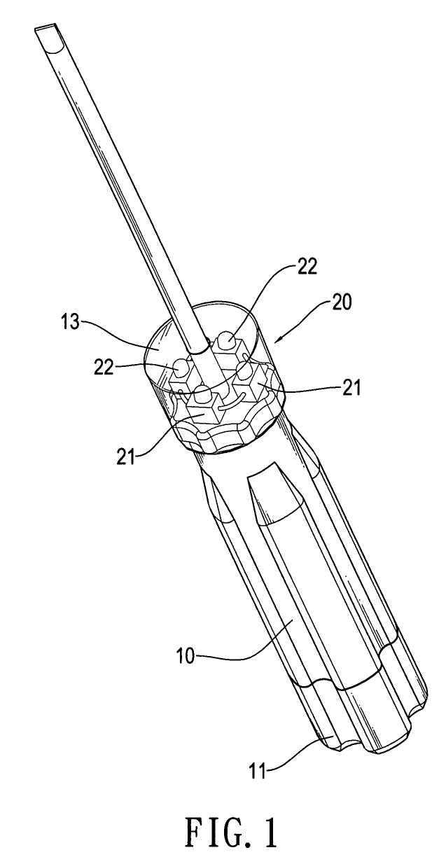

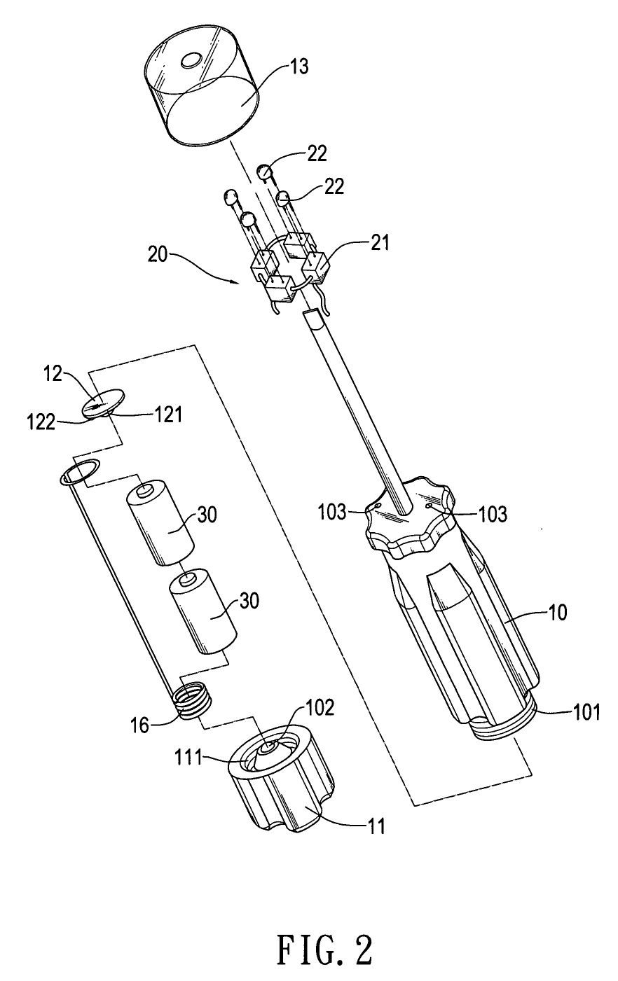

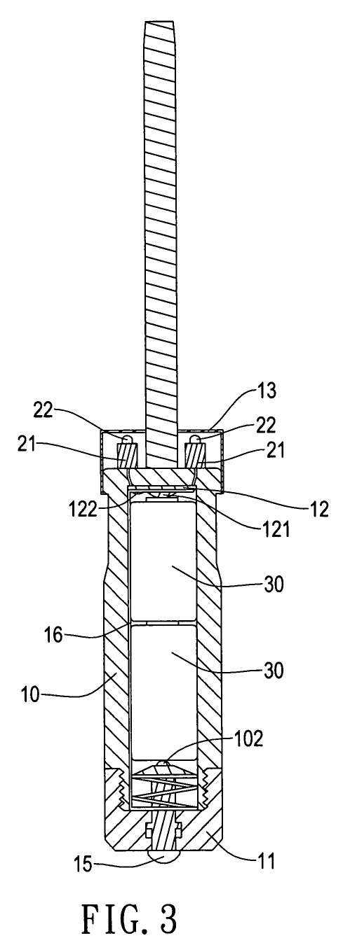

Referring to FIGS. 1 through 3, a tool structure with illumination of the present invention comprises a tool body 10, wherein the tool body 10 can further comprise a housing 13. A coupling part 101, which is an outer thread in this preferred embodiment, is formed on the rear end of the tool body 10. In addition, a rear cover 11 has a screwing part 111 formed thereon, wherein the screwing part 111 is an inner thread in this preferred embodiment. The screwing part 111 is designed to couple with the coupling part 101. In addition, two insertion holes 103 are formed on the front end of the tool body 10. The front end of the tool body 10 is designed for holding a light source group 20. The light source group 20 is composed of at least one electrical socket 21 and at least one light-emitting device 22. The light-emitting device 22, which is a light-emitting diode in this preferred embodiment, is mounted on the electrical socket 21. The light source group 20 is electrically connected to power cords or pins penetrating through the insertion holes 103 to electrically connect with one side of a circuit board 12 mounted inside the tool body 10. An anode-conducting bump 121 and a cathode-conducting bump 122 are mounted on the other side of the circuit board 12. In addition, at least one battery 30 is mounted inside the tool body 10. A switch button 15 is coupled to the rear cover 11. The switch button 15 is coupled to a cathode-conducting part 102. The cathode-conducting part 102 is connected to the cathode-conducting bump 122 mounted on the circuit board 12 via a conducting device 16. In addition, the cathode-conducting part 102 can be electrically connected with the cathode of the battery and the other side of the circuit board 12 can be electrically connected to the anode of the battery 30 by pushing the switch button 15 on the rear cover 11 so as to enable the battery 30 to supply electric power for the light-emitting device 22. As a result, the light-emitting device 22 can be turned on or turned off by controlling the switch button 15.

Referring to FIGS. 1 through 3, the present invention is featured in that the light source group 20 is mounted on the front end of the tool body 10. At least one light-emitting device 22 is mounted on the electrical socket 21 of the light source group 20 to project light beams on the operation position straightly. In addition, the light beams emitted laterally from the light-emitting device 22 can also provide illumination so that the operation position is free of the shadow region and can be provided with sufficient intensity of illumination without the use of additional lighting device. In addition, the light-emitting device 22 of the light source group 20 is inserted into the corresponding electrical socket 21 to enable the user himself to replace the damaged light-emitting device 22. In addition, the light color of the light-emitting device 22 is changeable by replacing the light-emitting device, thereby increasing variability and practicability.

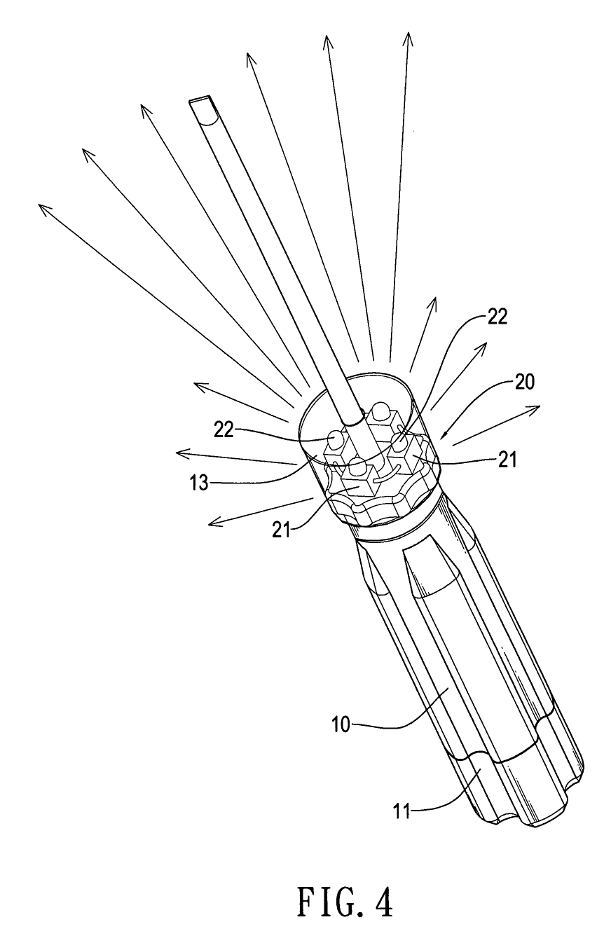

Referring further to FIG. 4, the utilization status of the tool structure with illumination of the present invention is shown. In this preferred embodiment, the tool structure is a screwdriver, but not limited thereto. Several electrical sockets 21 are circularly mounted on the front end of the tool body 10 for insertion thereinto of several light-emitting devices 22. In addition, the light source group 20 located on the front end of the tool body 10 is covered with a transparent housing 13 to enable the light-emitting devices 22 inserted into the electrical sockets 21 to radiate light beams straightly or toward the periphery of the housing 13 for providing the operation position with auxiliary illumination. In addition, the transparent housing 13 is so dustproof and waterproof that the light-emitting devices 22 and the electrical sockets 21 have extended usable lifetime.

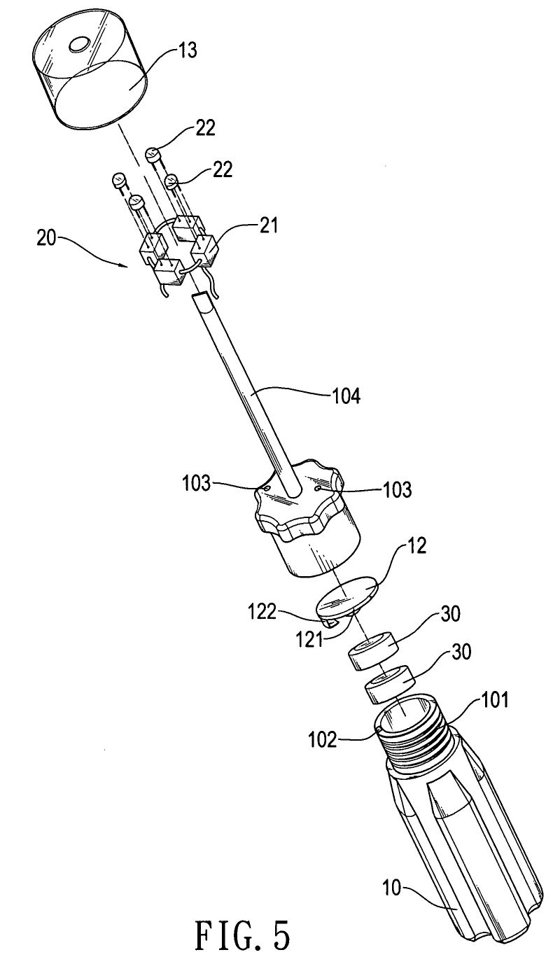

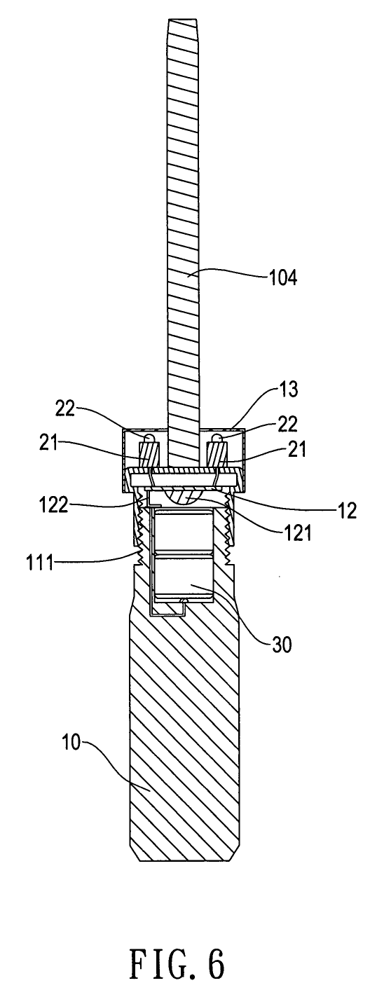

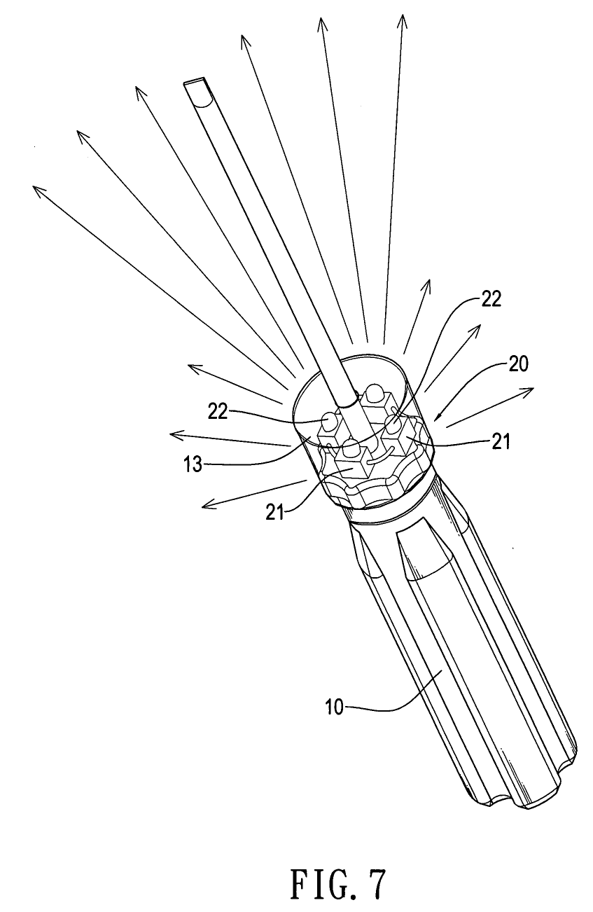

In this first preferred embodiment, as shown in FIGS. 1 through 4, the opening for insertion thereinto of the battery is formed on the rear end of the tool body 10. However, as shown in FIGS. 5 through 7, the opening for insertion thereinto of the battery may be formed on the front end of the tool body 10 according to a second preferred embodiment of the present invention, wherein a coupling part 101 is formed on the front end of the tool body 10. In addition, a screwing part 111 and two insertion holes 103 are formed on the screwdriver head 104. A light source group 20 is composed of at least one electrical socket 21 and at least one light-emitting device 22. The light-emitting device 22 is mounted on the electrical socket 21. The light source group 20 is electrically connected to power cords or pins penetrating through the insertion holes 103 to electrically connect with one side of a circuit board 12 mounted inside the tool body 10. An anode-conducting bump 121 and a cathode-conducting bump 122 are mounted on the other side of the circuit board 12. In addition, two batteries 30 are mounted inside the tool body 10. A cathode-conducting part 102 mounted on the front end of the tool body 10 can be connected to the cathode-conducting bump 122 mounted on the circuit board 12 by rotating the screwdriver head 104 so that the other side of the circuit board 12 can be electrically connected to or disconnected from the batteries 30 by controlling the electrical connection and disconnection between the cathode-conducting part 102 and the cathode of the battery 30. As a result, the light-emitting device 22 can be supplied with electric power by the batteries 30 and the lighting status of the light-emitting device 22 can be thus controlled. In addition, the light source group 20 located on the front end of the tool body 10 is covered with a transparent housing 13 to enable the light-emitting device 22 mounted on the electrical socket 21 to radiate light beams straightly or toward the periphery of the housing 13 for providing the operation position with auxiliary illumination. In addition, the transparent housing 13 is so dustproof and waterproof that the light-emitting device 22 and the electrical socket 21 have extended usable lifetime.

To sum up, the present invention is capable of achieving the aforementioned objects. The present invention discloses a tool structure with illumination, which has simplified structure, replaceable light-emitting device and low production cost. Therefore, this application is filed according to the patent law.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments, which do not depart from the spirit and scope of the invention.

What the invention claimed is:

1. A tool structure with illumination, comprising:
a tool body;
a light source group mounted on the front end of said tool body, said light source group being composed of at least one electrical socket and at least one light-emitting device, said at least one light-emitting device being mounted on said at least one electrical socket; and
at least one battery mounted inside said tool body for electrically connecting with said at least one electrical socket, whereby said at least one battery supplies electric power for said light source group for completing said tool structure with illumination.

2. A tool structure with illumination according to claim 1, further comprising a transparent housing mounted on the front end of said light source group for covering said light source group.

3. A tool structure with illumination according to claim 1, wherein said tool body is a screwdriver.

4. A tool structure with illumination according to claim 1, wherein said at least one light-emitting device is at least one light-emitting diode.

5. A tool structure with illumination according to claim 1, further comprising a circuit board mounted inside said tool body, wherein one side of said circuit board is electrically connected to said at least one battery and the other side of said circuit board is electrically connected to said at least one electrical socket of said light source group.
